(19) United States
(12) Patent Application Publication
(10) Pub. No.: US 2021/0136900 A1
(43) Pub. Date: May 6, 2021

(54) X-RAY TUBE MONITORING

(71) Applicant: Gulmay Limited, Surrey (GB)

(72) Inventors: Stuart Duncan, Surrey (GB); Tony Durrant, Surrey (GB)

(21) Appl. No.: 16/674,969

(22) Filed: Nov. 5, 2019

(51) Int. Cl. H05G 1/26; H05G 1/12

(52) U.S. Cl. CPC H05G 1/265; H05G 1/12

(57) ABSTRACT

A power transfer and monitoring system for an X-ray tube includes a transformer including a primary coil and a secondary coil, a current supply that supplies a sinusoidal current to the transformer, and a current calculation unit which measures the primary current of the transformer, and synthesises the transformer magnetising current, and which to subtract the synthesised transformer magnetising current from the primary current to generate a value for the filament current.

The present specification relates to X-ray tube monitoring, particularly monitoring the resistance of an X-ray tube filament.

A known type of X-ray generator includes an X-ray tube in which a cathode is heated, and the electrons from the cathode are accelerated to an anode, where the electrons produce an X-ray Photon flux. The cathode or electron emitter is typically a wound filament which has a current passed through it, and the X-ray Photon flux is related to the emission current from an electron emitter. The electron emission is directly related to the electrical filament power. There is therefore an important characteristic of any X-ray tube which relates the filament is power (voltage and current) to the emission current and photon flux at a given kV. This also means that the tube gain characteristic could be measured at the same time.

It would also be advantageous if the resistance of the filament could be continuously monitored in order to predict the X-ray tube's lifespan and warn when failure is to be expected.

Typically, X-ray tubes operate from a few kV up to 500 kV and beyond. The filament voltage which is normally only a few volts is referenced to the Extra High Tension (EHT) voltage across the X-ray tube. This means that to measure either filament current or voltage, whilst EHT is applied is extremely difficult.

If a filament measurement circuit was inserted between the generator and the tube, then the power to drive the measuring circuit would need to be supplied through a large isolation transformer; this would require the whole circuit to be placed in a tank full of insulating material such as transformer oil, and the output signal similarly isolated, before being fed back to be displayed; this itself is problematic, and transmission using fibre optics may be necessary. This would be an extremely cumbersome and expensive solution, and impractical in most normal situations.

A first objective of the present invention is to enable current and voltage data to be extracted for a resistive load (such as a wire wound filament of an X-ray tube) held at high voltage, such that a relationship between the load current, load voltage and electron emission current can be measured and continuously is monitored.

In an X-ray tube this emission current gives rise to an X-ray photon flux, which is the gain of the X-ray tube. With this data a characteristic gain plot of an X-ray tube can be produced.

An alternative but related objective of the present invention is to enable the trend toward end of life of the filament to be predicted.

This can be done by monitoring the filament current and voltage required to deliver a given electron emission current. The resistance of the filament can be calculated, so that as the filament wears and “thins” and its resistance increases the trend toward ultimate failure can be predicted.

According to the present invention, there is provided an X-ray tube monitoring system according to claim 1.

This system allows monitoring signals (principally the current, but voltage can be similarly calculated) to be extracted without having to connect directly to the filament. This allows filament life prediction; additionally, it allows gain plots for X-ray tubes to be easily generated.

The invention will now be described, by way of example, with reference to the drawings, of which

FIG. 1 is a diagrammatic representation of the monitoring system according to an embodiment of the invention;

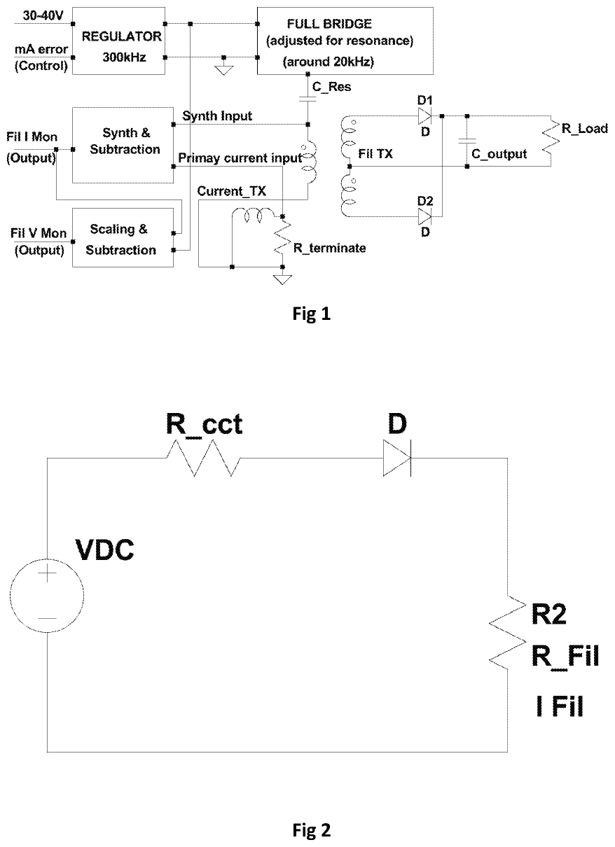

FIG. 2 is a diagrammatic representation of an approximate equivalent circuit of the system of FIG. 1;

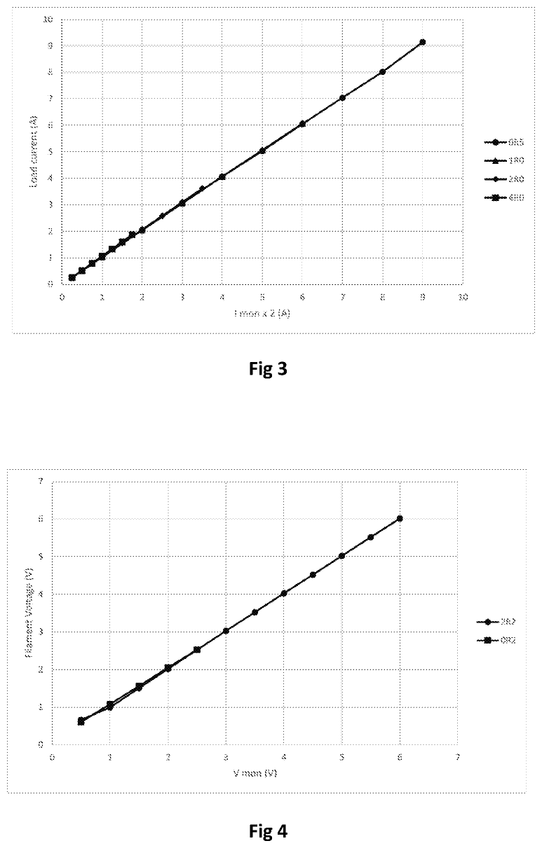

FIG. 3 is a plot of load current of a dummy load against 2× the monitor output of the system of FIG. 1

FIG. 4 is a plot of the filament voltage against monitor output of the system of FIG. 1

FIG. 5 is a plot of the filament characteristic of a Thales THX 225 WA using a GX225 X-ray generator calculated from measurements using the system of FIG. 1

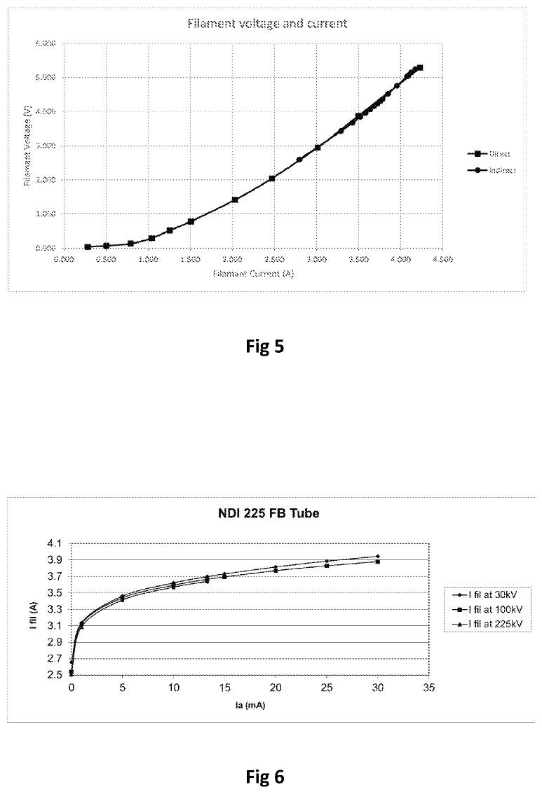

FIG. 6 is a gain plot of NDI 225 FB Tube obtained from measurements using the system of FIG. 1.

Referring to FIG. 1, a regulator supplies a dc voltage to a full bridge switching converter. The frequency of the full bridge converter is adjusted until resonance is achieved between C_RES and the leakage inductance of the transformer, so that a sinusoidal current of a single frequency is generated, that is, having no harmonic frequencies.

As the transformer primary current is sinusoidal it means that the secondary current is also sinusoidal. The transformer secondary voltage is full wave rectified and smoothed before being applied to the filament.

Large leakage inductances are associated with transformers with a large isolation tolerance; to reduce the effects of leakage inductance, a sinusoidal current drive is used. The full bridge resonant converter allows a square wave voltage drive to be used to provide a sinusoidal current drive. The current wave-shape contains very few harmonics, and therefore there is a fixed relationship between the dc filament current and the transformer secondary current. If then, the transformer primary current were measured, this would be proportional to secondary current if it wasn't for the transformer magnetising current giving an error. To correct for this error, the transformer magnetising current is determined (or “synthesised”) and subtracted from primary current to allow determination of the secondary and hence filament current.

The transformer primary current is measured using a current transformer terminated in resistor R terminate. From the primary voltage, a signal which is proportional to the transformer magnetising current is produced. This is subtracted from the signal proportional to the primary current, yielding a signal which is proportional to secondary, and hence filament current. The resulting filament current monitor is then used in a voltage scaling and subtraction unit to yield the filament voltage. The relationships between I_{Load} and I_{secondary}, I_{Primary}, I_{Secondary} and I_{Magnetising}, and I_{Monitor} and I_{Primary} and I_{Magnetising} are as follows:
I_{Load}∝I_{Secondary}
I_{Primary}∝I_{Secondary}+I_{Magnetising}
I_{Mon}∝I_{Primary}−I_{Magnetising}

The system model approximates to a voltage generator in series with a diode and resistor as shown in FIG. 2. If the voltage drop across the diode is known, and the value of R-cct is known together with the filament current, then by measuring VDC, the voltage across the filament can be deduced. To obtain these values, a measurement is carried out on the filament before EHT is applied. The filament characteristic is first plotted. Then, EHT is applied, and by calibrating the system back to the zero High Voltage measurement, a matching plot of the filament characteristic is produced.

Once this calibration has been done once for a given filament, the voltage can then be measured continuously through the life of the filament. From this a continuous gain plot of the X-ray tube can be produced through to the life of the filament.

As a filament wears, the core becomes thinner, until the point where it is destroyed. As the core becomes thinner, the filament resistance increases. If a measurement is taken at the start of life, and the filament is monitored throughout its life, the end of life can be predicted as the filament resistance starts to increase rapidly approaching failure.

The accuracy of using this system to measure the filament current and voltage has been demonstrated by experiment. The actual current of a dummy load against measured I mon output is shown plotted in FIG. 3, showing that the measured I mon output does indeed accurately reflect the load current. FIG. 4 shows the actual load voltage plotted against the V mon output, where it can be seen that the actual and measured voltages correspond reasonably closely.

FIG. 5 shows a filament characteristic; the squares line shows measurements that have been done directly (No EHT applied), whereas the circular-dot line shows the characteristic measured using the monitor outputs with EHT applied. FIG. 6 shows a gain plot of an X-ray tube produced with EHT applied, and using the monitor outputs.

1. A power transfer and monitoring system for an X-ray tube, including:
a transformer including a primary coil and a secondary coil;
a current supply that supplies a sinusoidal current to the transformer;
a current calculation unit which measures the primary current of the transformer, and synthesises the transformer magnetising current, and which to subtract the synthesised transformer magnetising current from the primary current to generate a value for the filament current.

2. A power transfer and monitoring system of claim 1, wherein there is included a voltage calculation unit which measures the voltage at the regulator output, and using the calculated filament current, to calculate the filament voltage.

3. A power transfer and monitoring system of claim 1, wherein there is included a resonant circuit which converts a high voltage supply waveform into the sinusoidal current supplied to the primary coil.

4. A power transfer and monitoring system according to claim 1, wherein there is provided a rectification circuit between the secondary coil and any X-ray tube connected to the secondary circuit.

5. A power transfer and monitoring system according to claim 4, wherein the rectification circuit includes two diodes connected to terminal legs of the secondary coil to supply a first contact of an X-ray tube, and a middle leg of the secondary coil to supply a second contact of the X-ray tube.
